(19) United States
(12) Patent Application Publication
(10) Pub. No.: US 2026/0260358 A1
(43) Pub. Date: Sep. 3, 2026

(54) METHODS AND SYSTEMS FOR GENERATING 3D WIREFRAMES

(71) Applicant: Dronebase, Inc., Los Angeles, CA (US)

(72) Inventors: Isaac A. Corley, San Antonio, TX (US); Jonathan R. Lwowski, San Antonio, TX (US)

(21) Appl. No.: 19/067,294

(22) Filed: Feb. 28, 2025

(51) Int. Cl. G06T 7/12; G06N 3/0464; G06N 3/08; G06T 7/60; G06T 17/20

(52) U.S. Cl. CPC G06T 7/12; G06N 3/0464; G06N 3/08; G06T 7/60; G06T 17/20; G06T 2207/10032; G06T 2207/20081; G06T 2207/20084; G06T 2207/30184

(57) ABSTRACT

Methods, apparatuses, and systems are described for generating three-dimensional (3D) model(s) of one or more objects. A computing device may receive an orthomosaic image of an environment comprising one or more objects. Data indicative of the orthomosaic image may be provided to a vision language model, wherein the vision language model may generate one or more 3D wireframe models of the one or more objects. The vision language model may comprise a first machine learning model that may determine one or more exterior boundaries associated with each object and height data associated with each object and a second machine learning model that may generate one or more interior boundaries associated with each object. Characterization data associated with each object may be determined based on each 3D wireframe of each object and displayed to a user via a user interface.

### BACKGROUND

Residential and/or commercial property owners approaching a major roofing project may be unsure of the amount of material needed and/or the next step in completing the project. Generally, such owners contact one or more contractors for a site visit. Each contractor must physically be present at the site of the structure in order to make a determination on material needs and/or time. The time and energy for providing such an estimate becomes laborious and may be affected by contractor timing, weather, contractor education, and the like. Moreover, roof measurement estimates may vary even between contractors causing variance in supply ordering as well. Additionally, measuring an actual roof may be costly and potentially hazardous, which may impact the completion of a proposed roofing project that depends on the ease in obtaining a roofing estimate.

Thus, imaging technologies are increasingly used to measure the roofs of buildings in order to generate measurement estimates for these buildings. Conventional object modeling technologies capture images of a scene or environment in order to generate a 3D map of the scene or environment. The modeling technologies are often used to capture multiple images of an object in the scene or environment in order to generate a 3D model of the object. These technologies often use multiple captured images in order to generate the 3D model. For instance, these modeling technologies require multiple captured images at different angles in order to generate a point cloud associated with the object that may be used to generate the 3D model of the object. However, generating these 3D models based on the use of multiple images, especially based on the generation of point clouds from the images, requires a substantial amount of memory and processing power, which does not allow for the generation of these 3D models on the fly via a single mosaic image. Moreover, these technologies require capturing oblique angles of each individual object, such as a building, as opposed to a large orthomosaic image of an entire neighborhood or city that allows for multiple objects, or buildings, to be captured and analyzed in order to generate 3D models of each object, or building, that may be captured in the single orthomosaic image.

### SUMMARY

It is to be understood that both the following general description and the following detailed description are exemplary and explanatory only and are not restrictive.

Methods, systems, and apparatuses for generating three-dimensional (3D) model(s) of one or more objects are described herein. A computing device may receive an orthomosaic image of an environment comprising one or more objects. Data indicative of the orthomosaic image may be provided to a vision language model, wherein the vision language model may generate one or more 3D wireframe models of the one or more objects based on the orthomosaic image. The vision language model may comprise a first vision language model that may determine one or more exterior boundaries and height data associated with each object and a second vision language model that may generate one or more interior boundaries associated with each object. The one or more 3D wireframe models of the one or more objects may be generated based on the one or more exterior boundaries and the one or more interior boundaries associated with each object and based on the height data associated with each object. Characterization data associated with each object may be determined based on each 3D wireframe of each object and displayed to a user via a user interface.

In an embodiment, are methods for receiving, by a device, from one or more imaging devices, image data of an environment comprising one or more objects, determining, based on an application of a first machine learning model to the image data, one or more exterior boundaries associated with each object of the one or more objects and height data associated with each object, segmenting, based on the one or more exterior boundaries associated with each object, the image data into one or more images associated with the one or more objects, generating, based on an application of a second machine learning model to each image of the one or more images, one or more interior boundaries associated with each object of the one or more objects, and generating, based on the one or more exterior boundaries associated with each object and the one or more interior boundaries associated with each object and based on the height data associated with each object, one or more digital representations associated with the one or more objects.

In an embodiment, are one or more non-transitory computer-readable media storing processor-executable instructions that, when executed by at least one processor, cause the at least one processor to receive, by a device, from one or more imaging devices, image data of an environment comprising one or more objects, generate, based on an application of a first machine learning model to the image data, one or more exterior boundaries associated with each object of the one or more objects and height data associated with each object, segment, based on the one or more exterior boundaries associated with each object, the image data into one or more images associated with the one or more objects, generate, based on an application of a second machine learning model to each image of the one or more images, one or more interior boundaries associated with each object of the one or more objects, and generate, based on the one or more exterior boundaries associated with each object and the one or more interior boundaries associated with each object and based on the height data associated with each object, one or more digital representations associated with the one or more objects.

In an embodiment, are systems comprising one or more imaging devices configured to output image data of an environment comprising one or more objects, and a computing device configured to receive the image data, generate, based on an application of a first machine learning model to the image data, one or more exterior boundaries associated with each object of the one or more objects and height data associated with each object, segment, based on the one or more exterior boundaries associated with each object, the image data into one or more images associated with the one or more objects, generate, based on an application of a second machine learning model to each image of the one or more images, one or more interior boundaries associated with each object of the one or more objects, and generate, based on the one or more exterior boundaries associated with each object and the one or more interior boundaries associated with each object and based on the height data associated with each object, one or more digital representations associated with the one or more objects.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for generating 3D wireframes;

FIG. 2 shows an example object measurement architecture;

FIG. 3 shows an example building segmentation and detection module;

FIG. 4 shows an example exterior measurements module;

FIG. 5 shows an example interior measurements module;

FIG. 6 shows an example user interface for displaying one or more 3D wireframes;

FIG. 7 shows an example machine learning system;

FIG. 8 shows an example convolutional neural network;

FIG. 9 shows an example structure of convolutional neural network;

FIG. 10 shows a flowchart of an example machine learning method; and

FIG. 11 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristors, Non-Volatile Random Access Memory (NVRAM), Random Access Memory (RAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

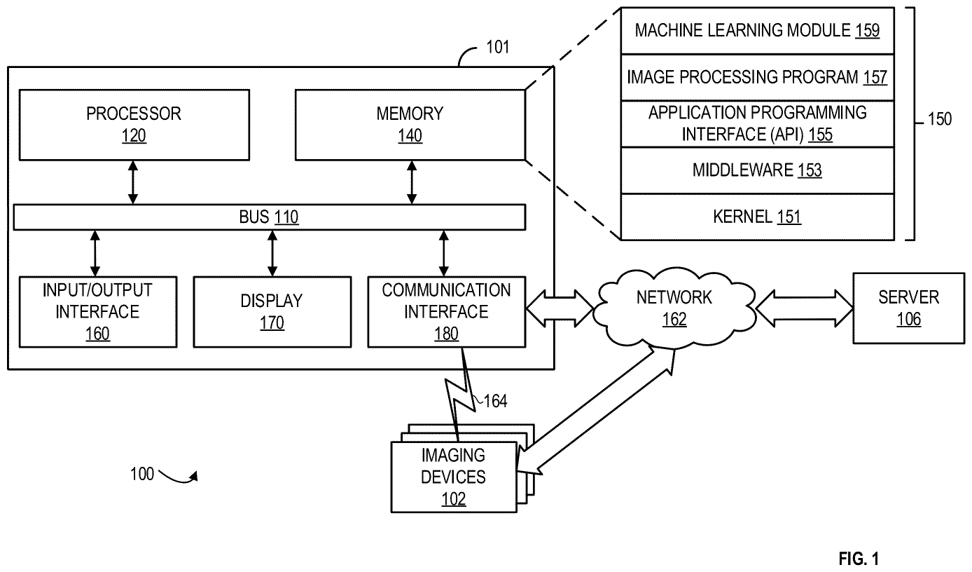

FIG. 1 shows an example system 100 for generating one or more three-dimensional (3D) wireframe models of one or more objects. A computing device (e.g., computing device 101) may receive image data of an environment comprising one or more objects. The computing device may provide the image data to a vision language model, wherein the vision language model may generate one or more 3D wireframe models of the one or more objects. The system 100 may include a computing device 101, a one or more imaging devices 102, and one or more external servers 106. The computing device 101 may comprise a laptop computer, a mobile phone, a smart phone, a tablet computer, a desktop computer, and the like. The computing device 101 may include a bus 110, a processor 120, a memory 140, an input/output interface 160, a display 170, and a communication interface 180. In an example, the computing device 101 may omit at least one of the aforementioned constitutional elements or may additionally include other constitutional elements.

The bus 110 may include a circuit for connecting the bus 110, the processor 120, the memory 140, the input/output interface 160, the display 170, and the communication interface 180 to each other and for delivering communication (e.g., a control message and/or data) between the bus 110, the processor 120, the memory 140, the input/output interface 160, the display 170, and the communication interface 180.

The processor 120 may include one or more of a Central Processing Unit (CPU), an Application Processor (AP), and a Communication Processor (CP). The processor 120 may control, for example, at least one of the memory 140, the input/output interface 160, the display 170, and the communication interface 180 and/or may execute an arithmetic operation or data processing for communication. The processing (or controlling) operation of the processor 120 according to various embodiments is described in detail with reference to the following drawings.

The memory 140 may include a volatile and/or non-volatile memory. The memory 140 may store, for example, a command or data related to at least one different constitutional element of the computing device 101. In an example, the memory 140 may store a software and/or a program 150. The program 150 may include, for example, a kernel 151, a middleware 153, an Application Programming Interface (API) 155, an image processing program (or an “application”) 157, and/or a machine learning module 159 or the like, configured for controlling one or more functions of the computing device 101 and/or an external device (e.g., the imaging devices 102). At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 130, etc.) used to execute an operation or function implemented in other programs (e.g., the middleware 153, the API 155, the image processing program 157, or the machine learning module 159). Further, the kernel 151 may provide an interface capable of controlling or managing the system resources by accessing individual constitutional elements of the computing device 101 in the middleware 153, the API 155, the image processing program 157, or the machine learning module 159.

The middleware 153 may perform, for example, a mediation role so that the API 145 or the image processing program 157 and the machine learning module 159 can communicate with the kernel 151 to exchange data.

Further, the middleware 153 may handle one or more task requests received from the image processing program 157 and/or the machine learning module 159 according to a priority. For example, the middleware 153 may assign a priority of using the system resources (e.g., the bus 110, the processor 120, or the memory 130) of the computing device 101 to at least one of the image processing programs 157 and/or the machine learning module 159. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, or character control, as an interface capable of controlling a function provided by the application 157 and/or the machine learning module 159 in the kernel 151 or the middleware 153.

As an example, the image processing program 157 and the machine learning module 159 may be independent of each other or integrally combined, in whole or in part, into a single processing program.

The image processing program 157 may include logic (e.g., hardware, software, firmware, etc.) that may be implemented for generating one or more 3D wireframes of one or more objects captured in an environment. The computing device 101 may receive image data associated with an environment from one or more imaging devices 102. As an example, the one or more imaging devices 102 may comprise external devices from the computing device 101 or may be integrated with the computing device 101 as a single device. The one or more imaging devices 102 may comprise one or more RGB imaging devices. The image data may comprise a single aerial image of the environment. For example, the one or more imaging devices 102 may be integrated with one or more aerial vehicles (e.g., one or more unmanned aerial vehicles), wherein the aerial vehicles may capture the imaging data as the aerial vehicles fly above one or more objects. For example, the imaging devices 102 may capture one or more characteristics (e.g., edges, sides, different angles, etc. associated with the one or more objects) associated with each object of the one or more objects. For example, the one or objects may comprise one or more buildings, wherein the one or more images may be captured from one or more angles of the buildings capturing one or more roofs, edges, sides, etc. of the one or more buildings. For example, the one or more characteristics may comprise a substantially planar surface (e.g., roof) comprising one or more edges along a perimeter with contours within an overall planar surface of each object. For example, the images being captured are substantially normal to a vertical of the buildings (e.g., not captured at substantially oblique angles). In an example, the image data may comprise a plurality of overlapping images of the environment that are stitched together into a single image (e.g., a single orthomosaic image). The computing device 101 may process the image data via a machine learning model 159 (e.g., vision language model) in order to generate one or more digital representations associated with the one or more objects. For example, the image processing program 157 may cause the computing device 101 to access the machine learning model 159 in order to generate the one or more digital representations. For example, a user may provide user input via a text prompt (e.g., a text prompt comprising “roof faces”) based on the image data, wherein the machine learning model 159 model may generate the one or more digital representations based on the image data and the text prompt.

The machine learning module/model 159 may include logic (e.g., hardware, software, firmware, etc.) to implement one or more machine learning modules/models for generating one or more exterior boundaries and/or one or more interior boundaries of the one or more objects. As an example, the machine learning module/model 159 (e.g., vision language model 159) may comprise a first machine learning model (e.g., a first vision language model) and a second machine learning model (e.g., a second vision language model). The first machine learning model may determine one or more exterior boundaries and height data associated with each object captured in the image data of the environment and the second machine learning model may generate one or more interior boundaries associated with each object. For example, the image data may be provided to the first machine learning model. The first machine learning model may be applied to the image data in order to determine the one or more exterior boundaries associated with each object of the one or more objects and the height data associated with each object. For example, the first machine learning model may generate a polygon per object (e.g., building) captured in the image data representing the one or more exterior boundaries of each object. For example, each polygon may comprise pixel coordinates associated with each of the one or more boundaries of each object. The image processing program 157 may cause the computing device 101 to segment the image data into one or more images associated with the one or more objects based on the one or more exterior boundaries associated with each object. For example, the image processing program 157 may cause the computing device 101 to crop an image, from the image data, to each object (e.g., building) based on the polygon generated for each object. For example, the polygon pixel coordinates may be used to generate a bounding box area (e.g., xmin, ymin, xmax, ymax) of each object that may be used to crop each image of each object of the one or more objects. For example, an image of each object determined in the image data may be generated from the image data (e.g., from the single orthomosaic image of the environment). Data indicative of each image of each object of the one or more objects may be provided to the second machine learning model. The second machine learning model may be applied to the data indicative of each image in order to generate one or more interior boundaries associated with each object.

The image processing program 157 may cause the computing device 101 to generate the one or more digital representations associated with the one or more objects based on the one or more exterior boundaries associated with each object and the one or more interior boundaries associated with each object and based on the height data associated with each object. The one or more digital representations associated with the one or more objects may comprise one or more 3D wireframe models of the one or more objects. In an example, the image processing program 157 may cause the computing device 101 to determine characterization data associated with each object based on each digital representation of the one or more digital representations. For example, the characterization data may comprise measurements (e.g., height at one or more points of the wireframe, lengths of one or more boundaries, etc.) associated with each object. In addition, the characterization data may further comprise characteristic information (e.g.., a length is too long, a width meets one or more measurement requirements, etc.) associated with the measurements associated with each object. The image processing program 157 may cause the computing device 101 to display the characterization data associated with each object overlaid with each object and the one or more exterior boundaries and the one or more interior boundaries of each object via a user interface. For example, the characterization data may be displayed based on one or more interactions with one or more of the digital representations of one or more of the objects via the user interface.

The input/output interface 160 may include an interface for delivering an instruction or data input from a user (e.g., an operator of the computing device 101) or from a different external device(s) (e.g., the imaging devise 102 and/or the servers 106) to the different elements of the processor 120, the memory 140, the input/output interface 160, the display 170, and the communication interface 180. The input/output interface 160 may further include an interface for outputting one or more user interfaces to the user. For example, the input/output interface 160 may comprise a display, such as a touch screen display, and/or one or more physical input interfaces (e.g., keyboard, mouse, etc.) configured to receive user inputs. For example, the input/output interface 160 may be configured to receive one or more user interactions associated with the one or more digital representations. Further, the input/output interface 160 may output an instruction or data received from one or more elements of the computing device 101 to one or more external devices (e.g., imaging devices 102 or servers 106).

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. The input processing program 157 may be implemented to cause the display 170 to output a user interface to display a captured environment of the image data comprising the one or more objects. In an example, each object of the one or more objects may be identified (e.g., outlined/highlighted) in the display in order to show each object that was detected in the captured environment. For example, the one or more exterior boundaries and the one or more interior boundaries of each object may be overlaid onto each object in the display. As an example, the characterization data associated with each object may be overlaid with each object. For example, the user interface may display the characterization data based on one or more user interactions with the user interface. For example, a user of the computing device 101 may interact with one or more of the exterior boundaries and/or interior boundaries of the one or more objects to determine (e.g., obtain) the characterization data associated with each of the one or more objects.

The communication interface 180 may establish, for example, communication between the computing device 101 and one or more external devices (e.g., the one or more imaging devices 102 and/or the server 106). For example, the communication interface 180 may communicate with the one or more external devices (e.g., the one or more imaging devices 102 and/or the server 106) by being connected to a network 162 through wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include at least one of a telecommunications network, a computer network (e.g., LAN or WAN), the Internet, and/or a telephone network.

In addition, the communication interface 180 may communicate with an external device (e.g., the one or more imaging devices 102 via communication path 164) via wireless communication or wired communication. The wireless communication 164 may include, for example, a near-distance communication. The near-distance communications 164 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication 164 may include, for example, at least one of Universal Serial Bus (USB), High Definition Multimedia Interface (HDMI), Recommended Standard-232 (RS-232), power-line communication, Plain Old Telephone Service (POTS), and the like.

The external servers 106 may include a group of one or more external servers. For example, all or some of the operations executed by the computing device 101 may be executed in a different server or a plurality of external servers 106. In an example, if the computing device 101 needs to perform a certain function or service either automatically or based on a request, the computing device 101 may request at least some parts of functions related thereto alternatively or additionally to a different server 106 or plurality of external servers 106 instead of executing the function or the service autonomously. One or more of the external servers 106 may execute the requested function or additional function, and may deliver a result thereof to the computing device 101. For example, the image process program 157 and/or the machine learning module(s) 159 may be located at the servers 106, wherein the computing device 101 may send the image data to the servers 106. The servers may implement the image process program 157 and/or the machine learning module(s) 159 to generate the one or more digital representations of the one or more objects and send the one or more digital representations to the computing device 101. The computing device 101 may provide the requested function or service either directly or by additionally processing the received result. For example, a cloud computing, distributed computing, or client-server computing technique may be used.

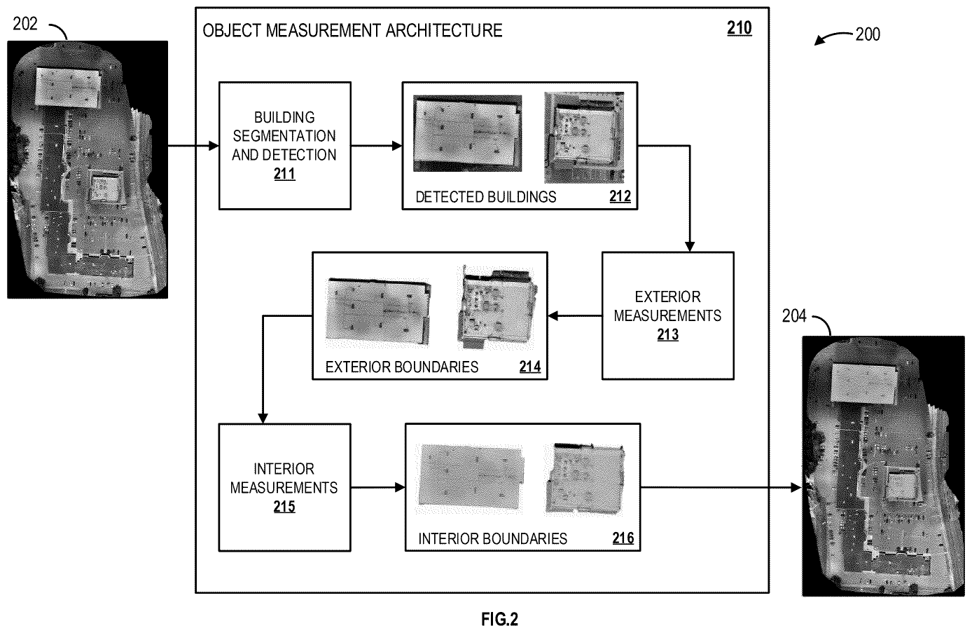

FIG. 2 shows an example object measurement architecture 200 configured to generate a 3D wireframe of one or more buildings (e.g., one or more objects) captured via image data of an environment. At 202, image data may be captured by one or more imaging devices (e.g., imaging devices 102). For example, the one or more imaging devices may comprise one or more RGB imaging devices integrated with one or more aerial vehicles (e.g., unmanned aerial vehicles), wherein the aerial vehicles may capture the imaging data as the aerial vehicles fly above one or more buildings. The image data may comprise a single aerial image of the environment comprising the one or more buildings. For example, the imaging devices 102 may capture an image of one or more to be identified characteristics (e.g., roofs, edges, sides, different angles, etc. associated with the one or more buildings) associated with each image captured building of the one or more image captured buildings. For example, the one or more images may be captured from one or more angles of the buildings capturing one or more roofs, edges, sides, etc. of the one or more buildings. For example, the one or more characteristics may comprise a substantially planar surface comprising one or more edges along a perimeter with contours within an overall planar surface of each building. For example, the images being captured are substantially normal to a vertical of the buildings (e.g., not captured at substantially oblique angles). In an example, the image data may comprise a plurality of overlapping images of the environment that may be stitched together into a single image (e.g., a single orthomosaic image). The image data may be provided to a machine learning model (e.g., a vision language model 159), wherein the machine learning model may generate one or more digital representations (e.g., 3D wireframe models) of the one or more buildings. As an example, the machine learning model may be incorporate into an object measurement architecture 210 implemented via a computing device (e.g., computing device 101). The machine learning model may comprise a first machine learning model (e.g., a first vision language model) and a second machine learning model (e.g., a second vision language model).

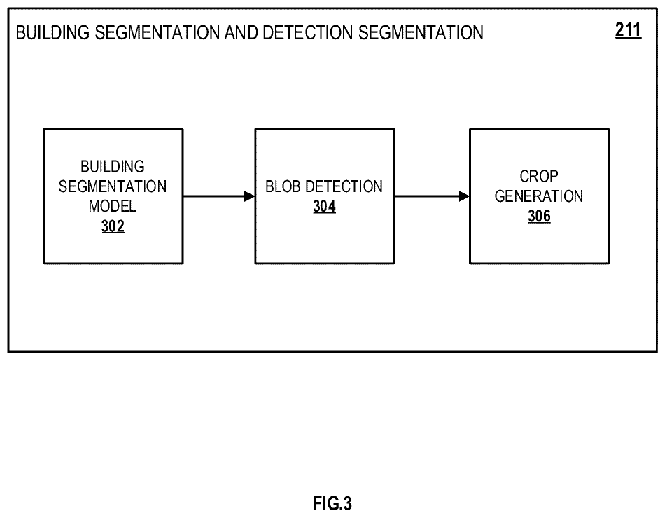

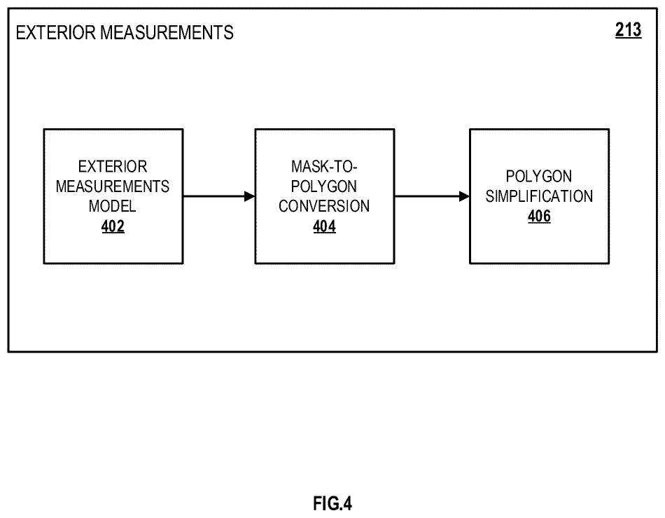

At 211, the image data may be provided to the first machine learning model. The first machine learning model may be applied to the image data in order to generate a polygon for each building captured in the image data. For example, as shown in FIG. 3, the first machine learning model (e.g., building segmentation model 302) may detect large blobs, at 304, in the image data via a segmentation mask associated with the one or more buildings. The image data may be segmented into one or more images associated with the one or more buildings based on the detected large blobs associated with the one or more buildings. For example, the image data may be cropped to generate one or more images associated with the one or more buildings based on the detected large blobs associated with the one or more buildings. For example, as shown in FIG. 3, the image data may be cropped, at 306, to a bounding box of each blob. For example, the detected large blobs may be used to generate a bounding box area (e.g., xmin, ymin, xmax, ymax) associated with the image data of each building that may be used to crop each image, from the image data, of each building of the one or more buildings. For example, an image of each building determined in the image data may be generated from the image data (e.g., from the single orthomosaic image of the environment). At 212, the one or more buildings may be detected/identified based on each of the cropped images associated with each of the one or more buildings. The exterior measurements may be determined for each of the one or more buildings at 213 based on each of the cropped images associated with each of the one or more buildings. For example, as shown in FIG. 4, an exterior measurements model 302 may be implemented to convert the segmentation masks, at 304, to polygons of the one or more buildings. At 306, as shown in FIG. 4, vertices of the polygons of the one or more buildings may be reduced (e.g., via the Douglas-Peucker algorithm). As an example, each polygon may comprise pixel coordinates associated with each building of the one or more buildings captured in the image data. The exterior boundaries may be determined for each of the one or more buildings at 214 based on the exterior measurements for each of the one or more buildings. In an example, height data may be may be determined based on the image data.

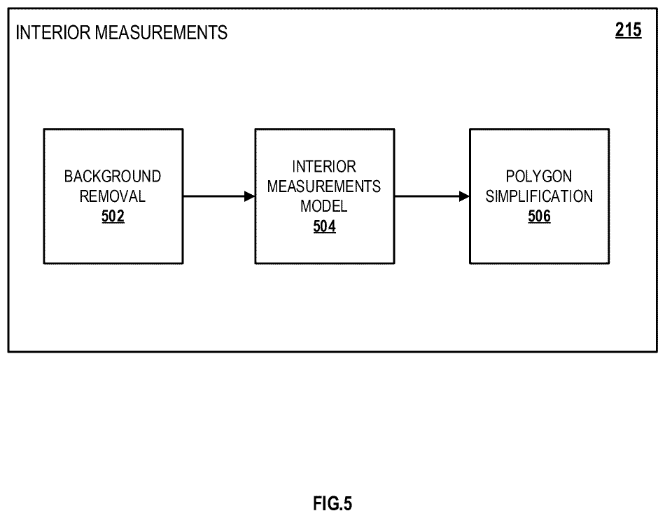

At 215, data indicative of each image of each object of the one or more objects may be provided to the second machine learning model. The second machine learning model may be applied to the data indicative of each image in order to determine interior boundaries of each of the one or more buildings. For example, as shown in FIG. 5, at 502 off-building pixels may be masked with values of zero using the exterior boundaries, wherein the mask may be provided to the interior measurements model 504. The interior measurement model 504 may then reduce vertices of each interior polygon (e.g., via the Douglas-Peucker algorithm) at 506. Data indicative of the interior measurements may be provided to the second machine learning model in order to generate one or more interior boundaries associated with each of the one or more buildings based on the interior measurements of each of the one or more buildings at 216. At 204, the object measurement architecture 210 may output one or more digital representations associated with the one or more buildings. The one or more digital representations associated with the one or more buildings may comprise one or more 3D wireframes of the one or more buildings. As an example, the one or more digital representations may comprise the one or more exterior boundaries and the one or more interior boundaries of each of the one or more buildings. In an example, the one or more digital representations may further comprise height data associated with each of the one or more buildings. In an example, characterization data associated with each building may be determined based on each digital representation of the one or more digital representations. For example, the characterization data may comprise measurements (e.g., height at one or more points of the wireframe, lengths of one or more boundaries, etc.) associated with each object. In addition, the characterization data may further comprise characteristic information (e.g.., a length is too long, a width meets one or more measurement requirements, etc.) associated with the measurements associated with each object. For example, the characterization data associated with each of the one more buildings may be overlaid with each of the one or more buildings and the one or more exterior boundaries and the one or more interior boundaries of each of the one or more buildings for display via a user interface.

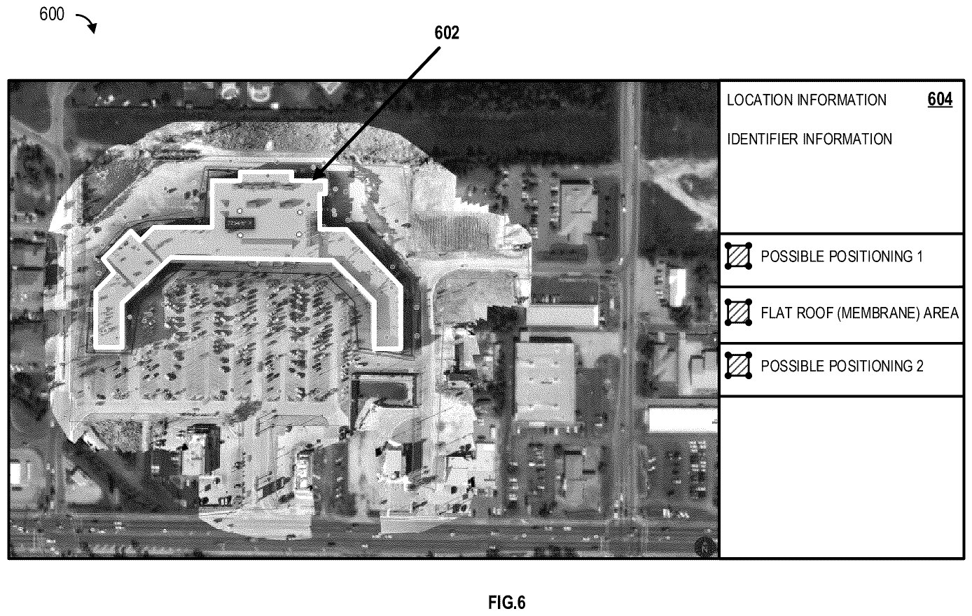

FIG. 6 shows an example user interface 600 for displaying one or more 3D wireframe models associated with one or more buildings captured in image data of an environment. For example, an imaging device may capture image data of an environment comprising the one or more buildings. The image data may be provided to a machine learning model (e.g., a vision language model), wherein the machine learning model may generate one or more 3D wireframe models associated with the one or more buildings based on the image data. As an example, the image data may be displayed via a user interface (e.g., user interface 600) to a user. As shown in FIG. 6, an outline 602 of a detected building may be overlaid on to the user interface 600 indicating the detected building. In addition, a portion of the user interface 600 may display one or more parameters 604 of the building such as location information (e.g., building address, geo location information, etc.) associated with the building, identifier information of the building (e.g., building name, type of business associated with the building, etc.), and the like. In an example, one or more of the parameters may be overlaid next to the building via the user interface 600. In an example, characterization data associated with the building may be determined based on the 3D wireframe model of the building. For example, the characterization data may comprise measurements (e.g., height at one or more points of the wireframe, lengths of one or more boundaries, etc.) associated with each object. In addition, the characterization data may further comprise characteristic information (e.g.., a length is too long, a width meets one or more measurement requirements, etc.) associated with the measurements associated with each object. In an example, the characterization data associated with the building may be overlaid on to the building and the one or more exterior boundaries and the one or more interior boundaries the building via the user interface 600. In another example, the characterization data may be displayed in a portion/section of the user interface 600. As an example, the characterization data may be displayed based on one or more interactions with the building via the user interface 600. For example, a user may interact with one or more portions, or one or more of the exterior and/or interior boundaries, of each object in order to obtain the characterization data associated with the one or more portions of each object.

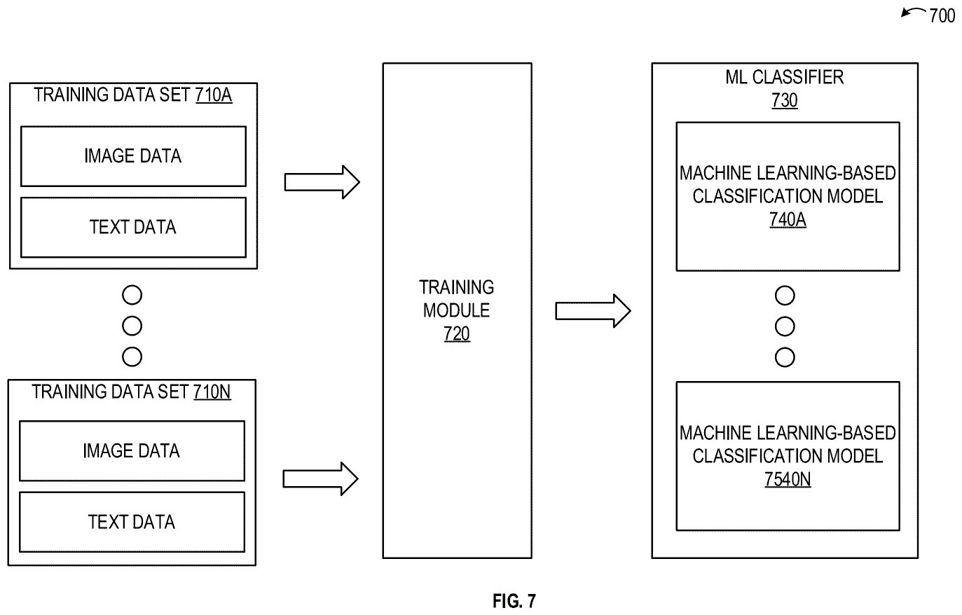

FIG. 7 shows an example system 700 that is configured to use machine learning techniques to train, based on an analysis of one or more training datasets 710A-710N by a training module 720, one or more machine learning-based classifiers 730. For example the machine learning modules/models 159 (e.g., the vision language models) may be trained according to system 700. The one or more machine learning models 730, once trained, may be configured to determine one or more exterior boundaries and one or more interior boundaries associated with one or more objects (e.g. one or more buildings) captured in image data of an environment. For example, a first machine learning model (e.g., a first vision language model) of the one or more machine learning models 730, once trained, may determine the one or more exterior boundaries associated with the one or more objects based on the image data and a second machine learning model (e.g., second vision language model), once trained, may generate the one or more interior boundaries associated with the one or more objects based on a cropped image of each of the one or more objects. A digital representation of each of the one or more objects may be generated based on the one or more exterior boundaries and the one or more interior boundaries of each of the one or more objects. For example, once trained, an image and text associated with a list of xy pixel coordinate points may be received, and a coordinate predictions of the roof vertices/corners of each roof may be output (e.g., roof-vertex<loc_x0><loc_y0>roof-vertex<loc_x1><loc_y1> . . . roof-vertex<loc_xN><loc_yN), wherein each roof has N vertices. A dataset indicative of, or comprising, image data (e.g., building rooftop data, etc.) and text data and a labeled (e.g., predetermined/known) prediction indicating a correlation between image data (e.g., a plurality of images of a variety of objects) and text data and boundaries of one or more objects may be used by the machine learning module 720 to train the one or more machine learning models 730. Each item of the image data and/or the text data in the dataset may be associated with a plurality of features that are present within the image data and/or the text data. The plurality of features and the labeled predictions may be used to train the at least one machine learning model 730.

The training datasets 710A-710N may each comprise one or more portions of the image data and/or the text data. The image data and/or the text data may have a labeled (e.g., predetermined) prediction and one or more labeled features. Each item of the image data and/or the text data may be randomly assigned to each of the training datasets 710A-710N and/or to one or more testing datasets. In some implementations, the assignment of the items of the image data and/or the text data to a training dataset or a testing dataset may not be completely random. In this case, one or more criteria may be used during the assignment, such as ensuring that similar numbers of image data and/or text data with different predictions and/or features are in each of the training and testing datasets. As an example, any suitable method may be used to assign the image data and/or the text data to the training or testing datasets, while ensuring that the distributions of predictions and/or features are somewhat similar in the training dataset and the testing dataset.

The machine learning module 720 may use portions of the training datasets 710A-710N to determine one or more features that are indicative of a high prediction. That is, the machine learning module 720 may determine which features present within the image data and/or the text data are correlative with a high prediction. The one or more features indicative of a high prediction may be used by the machine learning module 720 to train the machine learning model 730. For example, the machine learning module 720 may train the machine learning models 730 by extracting a feature set (e.g., one or more features) from a first portion of the training datasets 710A-710N according to one or more feature selection techniques. The machine learning module 720 may further define the feature set obtained from the training datasets 710A-710N by applying one or more feature selection techniques to a second portion in the training datasets 710A-710N that includes statistically significant features of positive examples (e.g., high predictions) and statistically significant features of negative examples (e.g., low predictions). The machine learning module 720 may train the machine learning models 730 by extracting a feature set from another training dataset of the training datasets 710A-710N that includes statistically significant features of positive examples (e.g., high predictions) and statistically significant features of negative examples (e.g., low predictions).

The machine learning module 720 may extract a feature set from the training datasets 710A-710N in a variety of ways. For example, the machine learning module 720 may extract a feature set from the training datasets 710A-510N using a classification module (e.g., a machine learning model). The machine learning module 720 may perform feature extraction multiple times, each time using a different feature-extraction technique. In one example, the feature sets generated using the different techniques may each be used to generate different machine learning models 740 (e.g., vision language model). For example, the feature set with the highest quality features (e.g., most indicative of exterior and interior boundaries of an object/building rooftop) may be selected for use in training. The machine learning module 720 may use the feature set(s) to build one or more machine learning models 740A-740N that are configured to determine exterior boundaries of an object based on image data (e.g., via a first vision language model) and generate interior boundaries of an object based on the data indicative of the exterior boundaries of the object (e.g., via a second vision language model).

The training datasets 710A-710N may be analyzed to determine any dependencies, associations, and/or correlations between features and the labeled predictions in the training datasets 710A-710N. The identified correlations may have the form of a list of features that are associated with different labeled predictions (e.g., boundaries of objects associated with textual descriptions). The term “feature,” as used herein, may refer to any characteristic of an item of data that may be used to determine whether the item of data falls within one or more specific categories or within a range. By way of example, the features described herein may comprise one or more features present within the image data and/or the text data that may be correlative (or not correlative as the case may be) with a feature associated with a boundary of an object associated with a textual description (e.g., “rooftop surfaces”).

A feature selection technique may comprise one or more feature selection rules. The one or more feature selection rules may comprise a feature occurrence rule. The feature occurrence rule may comprise determining which features in the training datasets 710A-710N occur over a threshold number of times and identifying those features that satisfy the threshold as candidate features. For example, any features that appear greater than or equal to 5 times in the training datasets 710A-710N may be considered as candidate features. Any features appearing less than, for example, 5 times may be excluded from consideration as a candidate feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to a first training dataset of the training datasets 710A-710N to generate a first list of features. A final list of features may be analyzed according to additional feature selection techniques to determine one or more candidate feature groups (e.g., groups of features that may be used to determine a prediction). Any suitable computational technique may be used to identify the feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 700. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the machine learning models 730 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the machine learning module 720 has generated a feature set(s), the machine learning module 720 may generate the one or more machine learning models 740A-740N (e.g., one or more vision language modules) based on the feature set(s). A machine learning model (e.g., any of the one or more machine learning models 740A-740N) may refer to a complex mathematical model for data classification that is generated using machine-learning techniques as described herein. In one example, a machine learning model may include a map of support vectors that represent boundary features. By way of example, boundary features may be selected from, and/or represent the highest-ranked features in, a feature set.

The machine learning module 720 may use the feature sets extracted from the training datasets 710A-710N to build the one or more machine learning models 740A-740N for each classification category (e.g., exterior/interior boundaries of one or more objects/buildings). In some examples, the one or more machine learning models 740A-740N may be combined into a single machine learning model 740 (e.g., an ensemble model). Similarly, the machine learning model 730 may represent a single classifier containing a single or a plurality of machine learning models 740 and/or multiple classifiers containing a single or a plurality of machine learning models 740 (e.g., an ensemble classifier).

The extracted features (e.g., one or more candidate features) may be combined in the one or more machine learning models 740A-740N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, generative artificial intelligence, convolutional neural networks, vision language models, etc.); generative pre-trained transformer; support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning model 730 may comprise a decision rule or a mapping for each candidate feature in order to assign a prediction to a class (e.g., of a boundary of an object vs. not of a boundary of an object). As described herein, the machine learning model 730 may be used to generate a digital representation (e.g., 3D wireframe model) of an object.

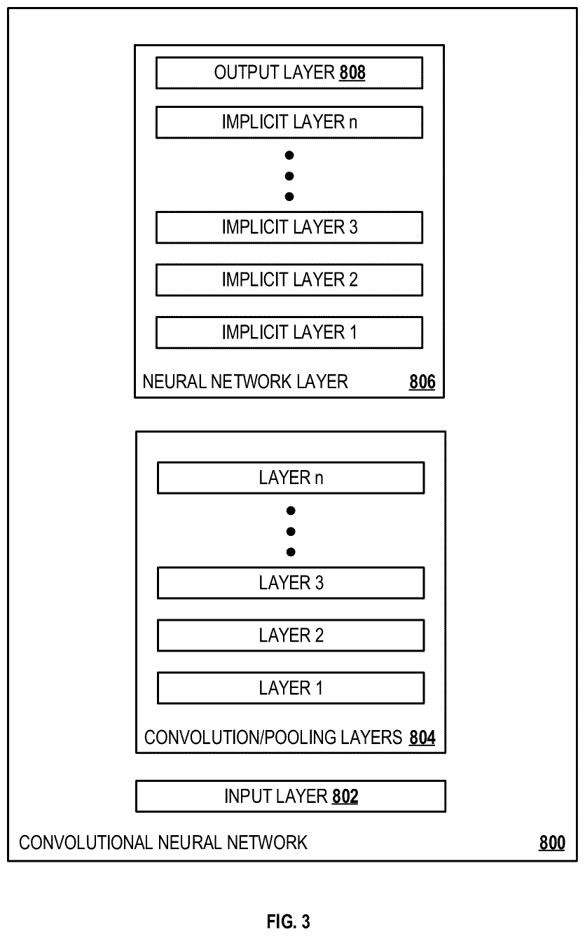

In an example, the one or more machine learning models may comprise one or more vison language models that utilize one or more convolutional neural networks for processing the images to generate the exterior and interior boundaries of the objects (e.g., buildings) detected in the image data. For example, FIG. 8 shows an example convolutional neural network 800 for processing image data. For example, a convolutional neural network 800 may include an input layer 802, convolution layers/pooling layers 804, and a neural network layer 806. The convolution layers/pooling layers 804 may include 1 to n number of layers. In one example, a first layer 1 may comprise a convolution layer while a next layer 2 may comprise a pooling layer which may be repeated for n layers. In another example, a first layer 1 and a next layer 2 may comprise convolution layers while a third layer 3 may comprise a pooling layer which may be repeated for n layers. As such, an output of a convolution layer may be used as an input of a following pooling layer or may be used as an input of another convolution layer to continue to perform convolution.

The first layer 1 (e.g., convolution layer) may include a plurality of convolution filters. A convolution filter may comprise a weight matrix. For example, during image processing, a convolution filter extracts specific information from an input image matrix. The weight matrix may process an image by processing one pixel after another pixel or two pixels after another two pixels in an input image along a horizontal direction in order to complete a task of extracting a specific feature (e.g., exterior boundary, interior boundary, etc.) from the image. A size of the weight matrix may be related to a size of the image. A depth dimension of the weight matrix may be the same as a depth dimension of the input image. During a convolution operation, the weight matrix may extend to an entire depth of the input image. The depth dimension may also comprise channel dimension, wherein the channel dimension may correspond to a quantity of channels (e.g., 3 channels). Thus, one convolutional output with a single depth dimension may be generated after convolution is performed by using a single weight matrix. In an example, a plurality of weight matrices with a same size (M rows×N columns) may be applied instead of a single weight matrix. Outputs of the weight matrices may be stacked to form a depth dimension of a convolutional image. In an example, different weight matrices may be used to extract different features of an image (e.g., image of an environment comprising one or more objects/buildings). For example, a weight matrix may be used to extract edge information of the image, another weight matrix may be used to extract a specific color of the image, and still another weight matrix may be used to blur unnecessary noise in the image. The plurality of weight matrices may have the same size (M rows×N columns). Feature graphs extracted by using the plurality of weight matrices with the same size may also have a same size. The plurality of extracted feature graphs with the same size may then be combined to form a convolution operation output. As an example, before convolution operations are performed by using convolution layers, secondary convolution filters may be obtained based on primary convolution filters of the convolution layers. A convolution operation may be performed on input image information at each convolution layer by using a primary convolution filter and a secondary convolution filter of the convolution layer.

When the convolutional neural network 800 has a plurality of convolution layers, an initial convolution layer (e.g., first layer 1) may extract a quantity of general features from an input image. The general feature may comprise a low-level feature. As a depth of the convolutional neural network 800 increases, a feature extracted by a subsequent convolution layer (e.g., layer 3) becomes more complex. For example, the feature may comprise a high-level feature. A higher-level feature may be more applicable to a to-be-resolved problem (e.g., determining exterior boundaries and interior boundaries of one or more objects/buildings captured in image data of an environment).

Pooling layers may be periodically introduced after convolution layers in order to reduce training parameters associated with the convolutional neural network 800. As an example, in layers 1 to n, as shown in FIG. 8, one convolution layer may be followed by one pooling layer, or a plurality of convolution layers may be followed by one or more pooling layers. During image processing, an objective of a pooling layer is to reduce a space size of an image. The pooling layer may be used to perform an average pooling operation and/or a maximum pooling operation in order to perform sampling on an input image to obtain a smaller-size image. The average pooling operation may be used to perform calculation on pixel values in the image in a specific range in order to generate an average value. The average value may comprise an average pooling result. The maximum pooling operation may be used to take a maximum pixel value in the specific range as a maximum pooling result. In addition, a size of a weight matrix at a convolution layer can be related to an image size, and similarly, an operator at a pooling layer may also be related to an image size. A size of an output image obtained through processing at a pooling layer may be smaller than a size of an input image of the pooling layer. Each pixel in an output image of the pooling layer may represent an average value or a maximum value of a corresponding sub-region of the input image of the pooling layer.

After processing is performed at the convolution layers/pooling layers 804, the convolutional neural network 800 still cannot output required output information (e.g., a determination of exterior boundaries and interior boundaries of one or more objects/buildings captured in image data of an environment), because as described above, at the convolution layers/pooling layers 804, only a feature is extracted, and parameters resulting from an input image are reduced. However, to generate final output information (e.g., a determination of exterior boundaries of one or more objects and/or interior boundaries of one or more objects), the convolutional neural network 800 needs to generate, by using a neural network layer 806, one output or a group of outputs that comprise a quantity that is equal to a quantity of required classes. Therefore, the neural network layer 806 may include a plurality of implicit layers (e.g., implicit layer 1 to implicit layer n, as shown in FIG. 8) and an output layer 808. Parameters included in the plurality of implicit layers may be obtained by performing pre-training based on training data. For example, the training data may comprise one or more input training datasets comprising a plurality of images that comprise environments with one or more objects (e.g., one or more buildings) and one or more output training datasets comprising a plurality of labeled images corresponding to a probability that one or more of the images comprises environments with one or more objects. For example, the training data may be associated with specific task types such as image recognition, image classification, and super-resolution image reconstruction.

An output layer 808 may be included after the plurality of implicit layers in the neural network layer 806. For example, the output layer 808 may comprise a last layer in the convolutional neural network 800. The output layer 808 has a loss function similar to classification cross entropy. The loss function may be used to calculate a predicted error. Once forward propagation (e.g., a propagation in a direction from 804 to 808) of the entire convolutional neural network 800 is completed, weighted values and offsets of the aforementioned layers start to be updated in backpropagation (e.g., a propagation in a direction from 808 to 804) in order to reduce a loss of the convolutional neural network 800 and an error between an ideal result (e.g., probability of exterior boundaries of one or more objects and/or interior boundaries of one or more objects captured in an image of an environment) and a result (e.g., exterior boundaries of one or more objects and/or interior boundaries of one or more objects captured in an image of an environment) output by the convolutional neural network 300 by using the output layer 308.

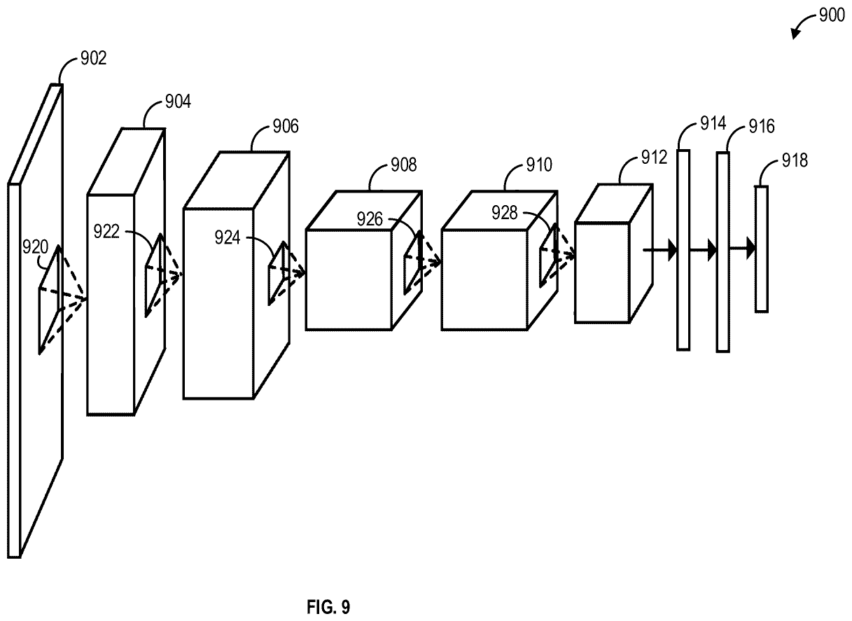

FIG. 9 shows an example structure of a convolutional neural network 900. As an example, the convolutional neural network 900 may include five convolution layers and three fully connected layers. Layers 902 to 910 may comprise input image information of a first convolution layer to a fifth convolution layer sequentially. Layers 904 to 912 may comprise output feature graphs of the first convolution layer to the fifth convolution layer sequentially. The fist convolution layer 902 to the fifth convolution layer 910 may comprise sliding windows 920 to 928, respectively (e.g., two-dimensional matrices). The sizes of the sliding windows 920 to 928, respectively, may be smaller than the sizes of the convolution layers 902 to 910. For example, the sizes (e.g., M rows×N columns×Channels) of the layers 902 to 912 may comprise 227×227×3, 55×55×96, 27×27×256, 13×13×384, 13×13×384, 13×13×256, respectively, while the sizes (e.g., M rows×N columns) of the sliding windows of each layer may comprise 11×11, 5×5, 3×3, 3×3, 3×3, respectfully. Layers 914 to 918 may comprise three fully connected layers. In an example, layer 914 may comprise a flatten layer, while layer 918 may comprise an output layer that outputs one or more feature classifications of an input image. For example, the output layer 918 may output exterior boundary and/or interior boundary features of one or more objects appearing in an image or classifications based on training the convolutional neural network.

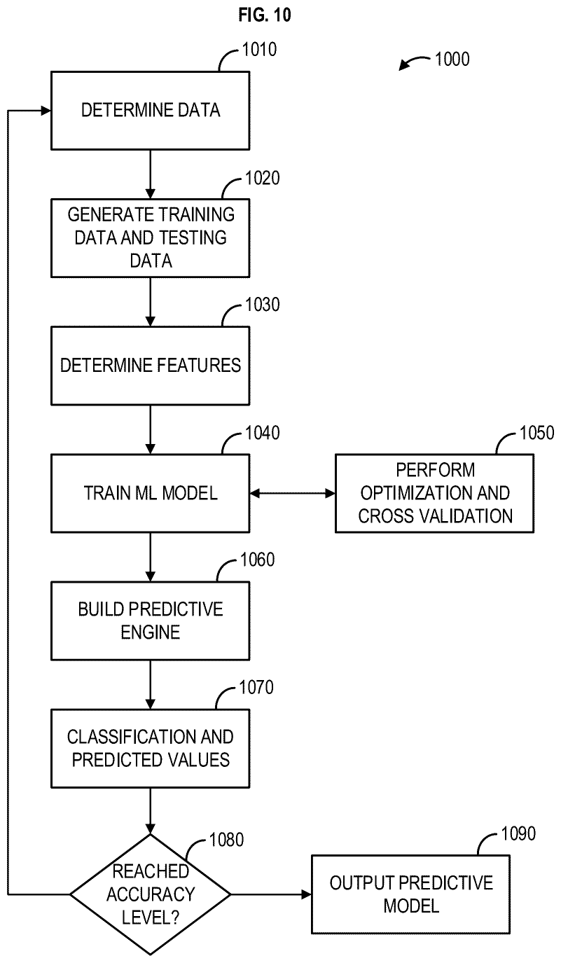

FIG. 10 shows a flowchart of an example training method 1000 for generating the machine leaning-based classifiers 730 using the training module 720. For example, the machine learning modules/models (e.g., vison language modules) may be trained according to method 1000. The training module 720 may be implement using supervised, unsupervised, and/or semi-supervised (e.g., reinforcement based) machine learning-based classification models 740 (e.g., vison language modules). In an example, the training module 720 may be implemented for a convolutional neural network by collecting labeled image data, preprocessing the images, designing the convolutional neural network architecture, feeding the data through the network, calculating a loss between predicted and actual labels, adjusting network weights using backpropagation to minimize the loss, and iterating through this process until the network reaches a desired accuracy level based on the training data.

At step 1010, the training method 1000 may determine (e.g., access, receive, retrieve, etc.) image data (e.g., a plurality of images of an environment that includes one or more objects/buildings) and/or text data. The image data and/or the text data may each comprise one or more features and a predetermined prediction. The training method 1000 may generate, at step 1020, a training dataset, and a testing dataset. The training dataset and the testing dataset may be generated by randomly assigning the image data and/or the text data to either the training dataset or the testing dataset. In some implementations, the assignment of the image data and/or the text data as training or test samples may not be completely random. As an example, only the image data and/or the text data for a specific feature(s) and/or range(s) of predetermined predictions may be used to generate the training dataset and the testing dataset. As another example, a majority of the image data and/or the text data for the specific feature(s) and/or range(s) of predetermined predictions may be used to generate the training dataset. For example, 75% of the image data and/or the text data for the specific feature(s) and/or range(s) of predetermined predictions may be used to generate the training dataset and 25% may be used to generate the testing dataset.

The training method 1000 may determine (e.g., extract, select, etc.), at step 1030, one or more features that may be used by, for example, a classifier to differentiate among different classifications (e.g., predictions). The one or more features may comprise a set of features. As an example, the training method 1000 may determine a set features from the image data and/or the text data. As another example, a set of features may be determined from other image data and/or other text data associated with a specific feature(s) and/or range(s) of predetermined predictions that may be different than the specific feature(s) and/or range(s) of predetermined predictions associated with the image data and/or the text data of the training dataset and the testing dataset. In other words, the other image data and/or the other text data may be used for feature determination/selection, rather than for training. The training dataset may be used in conjunction with the other image data and/or the other text data to determine the one or more features. The other image data and/or the other text data may be used to determine an initial set of features, which may be further reduced using the training dataset.

The training method 1000 may train one or more machine learning models (e.g., one or more machine learning models, neural networks, deep-learning models, text-based learning models, large language models, natural language processing applications/models, generative pre-trained transformers, vision language models, etc.) using the one or more features at step 1040. In one example, the machine learning models may be trained using supervised learning. In another example, other machine learning techniques may be used, including unsupervised learning and semi-supervised. The machine learning models trained at step 1040 may be selected based on different criteria depending on the problem to be solved and/or data available in the training dataset. In an example, machine learning models may suffer from different degrees of bias. Accordingly, more than one machine learning model may be trained at 1040, and then optimized, improved, and cross-validated at step 1050.

In an example, one or more convolutional neural networks (e.g., vision language models) may be trained based on the one or more training datasets. The image data (e.g., a plurality of images) of the one or more training datasets may be reformatted into a uniform format and size for input into the convolutional neural networks. The convolutional neural networks may process each image of the datasets to generate output vectors, wherein a highest value of each output vector (e.g., forward propagation) may represent a detected object class (e.g., exterior boundaries, interior boundaries, etc.). A loss function, or value, may be determined based on target values and actual values resulting from the output of the convolutional neural networks. The loss function may comprise a deviation value (e.g., target value minus actual value) that may be fed backward through all of the components of the convolutional neural networks until the deviation value reaches the starting layer of the convolutional neural networks (e.g., backpropagation). As an example, backpropagation allows the convolutional neural networks to determine how much each weight in the convolutional neural networks contributed to the errors and adjust each weight accordingly.

The training method 1000 may select one or more machine learning models to build the machine learning models 730 at step 1060. The machine learning models 730 may be evaluated using the testing dataset. The machine learning models 730 may analyze the testing dataset and generate classification values and/or predicted values (e.g., predictions) at step 1070. Classification and/or prediction values may be evaluated at step 1080 to determine whether such values have achieved a desired accuracy level. Performance of the machine learning models 730 may be evaluated in a number of ways based on a number of true positives, false positives, true negatives, and/or false negatives classifications of the plurality of data points indicated by the machine learning models 730.

For example, the false positives of the machine learning models 730 may refer to a number of times the machine learning models 730 incorrectly assigned a high prediction to a data input associated with a low predetermined prediction. Conversely, the false negatives of the machine learning models 730 may refer to a number of times the machine learning model assigned a low prediction to a data input associated with a high predetermined prediction. True negatives and true positives may refer to a number of times the machine learning models 730 correctly assigned predictions to each data input based on the known, predetermined prediction for each data input. Related to these measurements are the concepts of recall and precision. Generally, recall refers to a ratio of true positives to a sum of true positives and false negatives, which quantifies a sensitivity of the machine learning models 730. Similarly, precision refers to a ratio of true positives a sum of true and false positives. When such a desired accuracy level is reached, the training phase ends and the machine learning model 730 may be output at step 1090; when the desired accuracy level is not reached, however, then a subsequent iteration of the training method 1000 may be performed starting at step 1010 with variations such as, for example, considering a larger collection of image data and/or text data. The machine learning model 730 may be output at step 190.

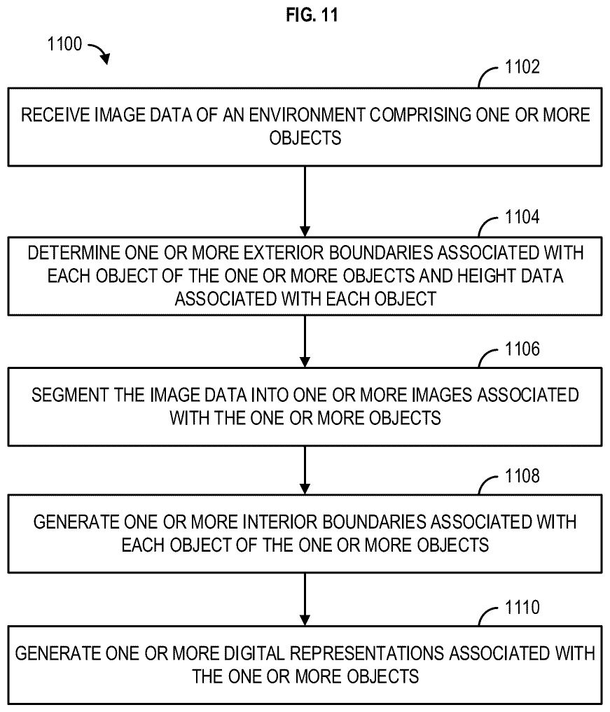

FIG. 11 shows a flowchart of an example method 1100 for generating 3D wireframe models of one or more objects. Method 1100 may be implemented by a computing device (e.g., computing device 101, servers 106, etc., or any combination thereof). At step 1102, image data of an environment comprising one or more objects may be received. For example, a computing device (e.g., computing device 101, servers 106, etc.) may receive the image data of an environment from one or more imaging devices. The one or more imaging devices may comprise one or more RGB imaging devices. The image data may comprise a plurality of overlapping images of the environment stitched together into a single image (e.g., a single orthomosaic image). In an example, the image data may comprise a single aerial image of the environment. For example, the one or more imaging devices may be integrated with one or more aerial vehicles (e.g., unmanned aerial vehicles), wherein the aerial vehicles may capture the imaging data as the aerial vehicles fly above the one or more objects. For example, the image data may comprise one or more images associated with one or more characteristics (e.g., edges, sides, different angles, etc. associated with the one or more objects) associated with each object of the one or more objects. For example, the one or more characteristics may comprise a substantially planar surface comprising one or more edges along a perimeter with contours within an overall planar surface of each object. The one or more objects may comprise one or more buildings.

At step 1104, one or more exterior boundaries associated with each object of the one or more objects and height data associated with each object may be determined based on an application of a first machine learning model to the image data. For example, the computing device (e.g., computing device 101, servers 106, etc.) may determine the one or more exterior boundaries associated with each object of the one or more objects and the height data associated with each object based on an application of the first machine learning model to the image data. The first machine learning model may comprise a vision language model. For example, the first machine learning model may generate a polygon per object captured in the image data representing the one or more exterior boundaries of each object. For example, each polygon may comprise pixel coordinates associated with each of the one or more boundaries of each object.

At step 1106, the image data may be segmented into one or more images associated with the one or more objects based on the one or more exterior boundaries associated with each object. For example, the computing device (e.g., computing device 101, servers 106, etc.) may segment the image data into the one or more images associated with the one or more objects based on the one or more exterior boundaries associated with each object. For example, an image may be cropped, from the image data, to each object based on the polygon generated for each object. For example, the polygon pixel coordinates may be used to generate a bounding box area (e.g., xmin, ymin, xmax, ymax) of each object that may be used to crop each image, from the image data, of each object of the one or more objects. For example, an image of each object determined in the image data may be generated from the image data (e.g., from the single orthomosaic image of the environment).

At step 1108, one or more interior boundaries associated with each object of the one or more objects may be generated based on an application of a second machine learning model to each image of the one or more images. For example, the computing device (e.g., computing device 101, servers 106, etc.) may generate the one or more interior boundaries associated with each object of the one or more objects based on an application of the second machine learning model to each image of the one or more images. The second machine learning model may comprise a vision language model.

At step 1110, one or more digital representations associated with the one or more objects may be generated based on the one or more exterior boundaries associated with each object and the one or more interior boundaries associated with each object and based on the height data associated with each object. For example, the computing device (e.g., computing device 101, servers 106, etc.) may generate the one or more digital representations associated with the one or more objects based on the one or more exterior boundaries associated with each object and the one or more interior boundaries associated with each object and based on the height data associated with each object. The one or more digital representations associated with the one or more objects may comprise one or more 3D wireframe models of the one or more objects. In an example, characterization data associated with each object may be determined based on each digital representation of the one or more digital representations, wherein a user interface may display the characterization data associated with each object overlaid with each object and the one or more exterior boundaries and the one or more interior boundaries of each object. For example, the characterization data may comprise measurements (e.g., height at one or more points of the wireframe, lengths of one or more boundaries, etc.) associated with each object. In addition, the characterization data may further comprise characteristic information (e.g., a length is too long, a width meets one or more measurement requirements, etc.) associated with the measurements associated with each object. For example, the characterization data may be displayed based on one or more interactions, by a user, with one or more of the buildings via the user interface.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, by a device, from one or more imaging devices, image data of an environment comprising one or more objects;
determining, based on an application of a first machine learning model to the image data, one or more exterior boundaries associated with each object of the one or more objects and height data associated with each object;
segmenting, based on the one or more exterior boundaries associated with each object, the image data into one or more images associated with the one or more objects;
generating, based on an application of a second machine learning model to each image of the one or more images, one or more interior boundaries associated with each object of the one or more objects; and
generating, based on the one or more exterior boundaries associated with each object and the one or more interior boundaries associated with each object and based on the height data associated with each object, one or more digital representations associated with the one or more objects.

2. The method of claim 1, wherein the image data comprises a plurality of overlapping images of the environment stitched together into a single image.

3. The method of claim 1, wherein the image data comprises a single aerial image of the environment.

4. The method of claim 1, wherein the image data comprises one or more images associated with one or more characteristics associated with each object of the one or more objects, wherein the one or more characteristics comprise a substantially planar surface comprising one or more edges along a perimeter with contours within an overall planar surface of each object.

5. The method of claim 1, wherein the one or more objects comprise one or more buildings.

6. The method of claim 1, wherein one or more of the first machine learning model or the second machine learning model comprises a vision language model.

7. The method of claim 1, wherein the one or more digital representations associated with the one or more objects comprise one or more 3D wireframes of the one or more objects.

8. The method of claim 1, further comprising:
determining, based on each digital representation of the one or more digital representations, characterization data associated with each object; and
displaying, via a user interface, the characterization data associated with each object overlaid with each object and the one or more exterior boundaries and the one or more interior boundaries of each object.

9. One or more non-transitory computer-readable media storing processor-executable instructions that, when executed by at least one processor, cause the at least one processor to:
receive, by a device, from one or more imaging devices, image data of an environment comprising one or more objects;
generate, based on an application of a first machine learning model to the image data, one or more exterior boundaries associated with each object of the one or more objects and height data associated with each object;
segment, based on the one or more exterior boundaries associated with each object, the image data into one or more images associated with the one or more objects;
generate, based on an application of a second machine learning model to each image of the one or more images, one or more interior boundaries associated with each object of the one or more objects; and
generate, based on the one or more exterior boundaries associated with each object and the one or more interior boundaries associated with each object and based on the height data associated with each object, one or more digital representations associated with the one or more objects.

10. The non-transitory computer-readable media of claim 9, wherein the image data comprises a plurality of overlapping images of the environment stitched together into a single image.

11. The non-transitory computer-readable media of claim 9, wherein the image data comprises one or more images associated with one or more characteristics associated with each object of the one or more objects, wherein the one or more characteristics comprise a substantially planar surface comprising one or more edges along a perimeter with contours within an overall planar surface of each object.

12. The non-transitory computer-readable media of claim 9, wherein the one or more objects comprise one or more buildings.

13. The non-transitory computer-readable media of claim 9, wherein the one or more digital representations associated with the one or more objects comprise one or more 3D wireframes of the one or more objects.

14. The non-transitory computer-readable media of claim 9, wherein processor-executable instructions, when executed by the at least one processor, further cause the at least one processor to:
determine, based on each digital representation of the one or more digital representations, characterization data associated with each object; and
output, via a user interface, the characterization data associated with each object overlaid with each object and the one or more exterior boundaries and the one or more interior boundaries of each object.

15. A system comprising:
one or more imaging devices configured to output image data of an environment comprising one or more objects; and
a computing device configured to:
receive the image data,
generate, based on an application of a first machine learning model to the image data, one or more exterior boundaries associated with each object of the one or more objects and height data associated with each object,
segment, based on the one or more exterior boundaries associated with each object, the image data into one or more images associated with the one or more objects,
generate, based on an application of a second machine learning model to each image of the one or more images, one or more interior boundaries associated with each object of the one or more objects, and
generate, based on the one or more exterior boundaries associated with each object and the one or more interior boundaries associated with each object and based on the height data associated with each object, one or more digital representations associated with the one or more objects.

16. The system of claim 15, wherein the image data comprises a plurality of overlapping images of the environment stitched together into a single image.

17. The system of claim 15, wherein the image data comprises one or more images associated with one or more characteristics associated with each object of the one or more objects, wherein the one or more characteristics comprise a substantially planar surface comprising one or more edges along a perimeter with contours within an overall planar surface of each object.

18. The system of claim 15, wherein the one or more objects comprise one or more buildings.

19. The system of claim 15, wherein the one or more digital representations associated with the one or more objects comprise one or more 3D wireframes of the one or more objects.

20. The system of claim 15, wherein the computing device is further configured to:
determine, based on each digital representation of the one or more digital representations, characterization data associated with each object; and
output, via a user interface, the characterization data associated with each object overlaid with each object and the one or more exterior boundaries and the one or more interior boundaries of each object.
